(19) United States
(12) Patent Application Publication
(10) Pub. No.: US 2010/0030728 A1
(43) Pub. Date: Feb. 4, 2010

(54) COMPUTING SELECTIVITIES FOR GROUP OF COLUMNS AND EXPRESSIONS

(75) Inventors: Sunil P. Chakkappen, Foster City, CA (US); Mohamed Zait, San Jose, CA (US)

Correspondence Address: HICKMAN PALERMO TRUONG & BECKER LLP, SUITE 550, 2055 GATEWAY PLACE, SAN JOSE, CA, 95110, US

(73) Assignee: ORACLE INTERNATIONAL CORPORATION

(21) Appl. No.: 12/181,994

(22) Filed: Jul. 29, 2008

(51) Int. Cl. G06F 17/30

(52) U.S. Cl. 707/2; 707/E17.017

(57) ABSTRACT

Techniques are described herein for estimating selectivities of query predicates that reference more than one column and predicates that include column expressions. Virtual columns are defined based on column groups and column expressions. Statistics are gathered on the virtual columns and are used to estimate the selectivities of query predicates that include column groups or expressions. Query predicates that include column groups are mapped to virtual columns on which statistics are gathered, based on similarities between the column groups in the query predicates and the column groups on which the virtual columns are defined. Virtual columns are defined for column groups and expressions are specified by users or a workload analyzer that analyzes query predicates.

### FIELD OF THE INVENTION

The present invention relates to database systems, and in particular, to techniques for gathering information on and using columns and expressions in database systems.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example of a table containing five columns.

FIG. 2 illustrates an example of histogram statistics for a column in a table.

FIG. 3 illustrates an example system for gathering statistics for column groups and expressions and for utilizing the gathered statistics.

FIG. 4 is a diagram of a computer system that may be used in an implementation of an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Introduction

In a database management system (DBMS), data is stored in one or more data containers, each container contains records, and the data within each record is organized into one or more fields. In relational DBMSs, the data containers are referred to as tables, the records are referred to as rows, and the fields are referred to as columns.

To retrieve data from tables in relational DBMSs, queries are submitted to a database server, which processes the queries and returns the data requested. Users may use a database query language, such as SQL, to specify queries in a variety of ways.

Queries submitted to a database server are evaluated by a query optimizer. When a query optimizer evaluates a query, it generates various “candidate execution plans” and estimates a query execution cost for each execution plan. The candidate execution plan with the lowest estimated query cost is assumed to be the most efficient and is then selected by the query optimizer as the execution plan to be carried out.

Estimating a query cost can be very complex, and a query optimizer may estimate cardinality (the number of rows to scan and process), selectivity (the fraction of rows from a row set filtered by a predicate), and cost in terms of resources such as disk input and output, CPU usage, and memory usage of the various candidate execution plans in the process of determining the most efficient execution plan from several candidate execution plans.

To estimate selectivity, or how many rows from a table will satisfy a predicate, query optimizers utilize statistical data gathered on columns in tables. Predicates in a database query language specify criteria for queries. For example, a query in a candidate execution plan may request all rows from a particular table which satisfy the predicate that the value in a row a particular column in the particular table is equal to 4.

```
Q1 = SELECT *
      FROM t1
      WHERE c1 = 4
```

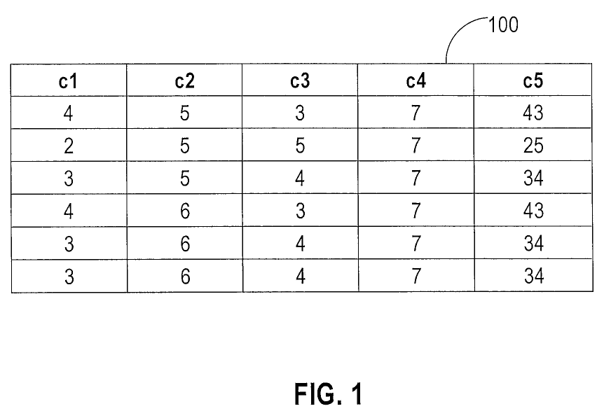

The query Q1 requests all rows from table t1 which contain values equal to 4 in column c1. Table 100 in FIG. 1 illustrates an example of a table t1 with example values in column c1. When a query optimizer evaluates a query statement like Q1, it utilizes column statistics to predict the number of rows that will satisfy the predicate in Q1 (“WHERE c1=4”) without performing the query itself.

Column statistics for c1 may be kept in the form of a “number of distinct values” (also referred to as “NDV”). The NDV of a column is the number of values in the column which are distinct from other values in the column. For example, in table 100, column c1 has an NDV of 3 because there are three distinct values—2, 3, and 4—in column c1. One way of estimating the selectivity of a column is to estimate the selectivity as the inverse of the column's NDV. For column c1 in table 100, the selectivity estimate is the inverse of three, which is one-third. In other words, it is estimated that a predicate such as “WHERE c1=4” will be satisfied by one-third of the rows in table 100. One-third of the rows in table 100, which contains a total of six rows, is two rows. Note that coincidentally, table 100 indeed contains two rows whose values in column c1 are 4.

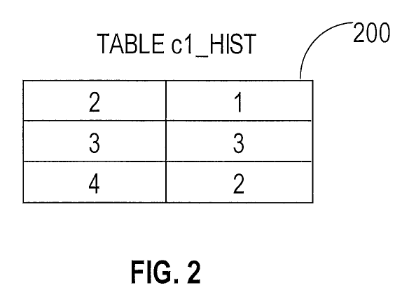

Column statistics can also be kept in the form of histograms which indicate a distribution of values in a column. Selectivity can then be estimated based on a column's histogram statistics. For example, table 200 in FIG. 2 illustrates an example of a histogram table, c1_HIST, for the c1 column in table 100. Table 200 contains two columns. The left column contains the distinct values that are in column c1, and the right column contains the corresponding frequency of occurrence for the distinct values. Table 200 illustrates that the value 2 occurs only once in column c1, the value 3 occurs three times in column c1, and the value 4 occurs two times in column c1. Based on the data in table 200, a selectivity estimate for the value 4 can be made by calculating the ratio of the frequency of occurrence for value 4 to the total frequency of occurrence for all the values. In this case, the ratio is 2:6, or one-third.

The example in table 200 is a simple frequency histogram. The overhead of storing this histogram is high if there are a large number of distinct values. There are other types of histograms that require less storage. A height balanced histogram is one example of a type of histogram that requires less storage. A height balanced histogram is created by sorting the values of a column and dividing the values into buckets in such a way that each bucket contains the same number of values. The last value in each bucket is then stored as the height balanced histogram. The selectivity for a value is estimated to be the number of times a value appears in the height balanced histogram divided by the total number of buckets.

### Column Groups and Column Expressions in Predicates

Predicates in query statements are often more complex than the simple “WHERE c1=4” predicate illustrated in query Q1 above. For example, a predicate may be a conjunctive predicate that references more than one column. Query Q2 illustrates a conjunctive predicate that contains two individual predicates, each referencing a different column.

```
Q2 = SELECT *
      FROM customers
      WHERE (country_id = ‘US’)
              AND (cust_state_province = ‘CA’)
```

Query Q2 queries for rows in table customers that contain the value “‘US’” in the country_id column and the value “‘CA’” in the cust_state_province column. To calculate the selectivity for the conjunctive predicate “WHERE (country_id=‘US’) AND (cust_state_province=‘CA’)” in Q2, one method estimates the selectivity as the product of the selectivities of the individual predicates. The selectivities of the individual predicates are separately estimated based on separate column statistics for the columns referenced in the individual predicates. Estimation of the selectivity of an individual predicate can be performed with the methods discussed above. The estimated selectivities of the individual predicates are then multiplied together to reach an estimate of the conjunctive predicate.

For example, if the table customers contains 630 rows total, 165 rows that satisfy “WHERE country_id=‘US’”, and 29 rows that satisfy “WHERE cust_state_province=‘CA’”, then the estimated selectivity for “WHERE country_id=‘US’” is 165/630, or 0.26190, and the estimated selectivity for “WHERE cust_state_province=‘CA’” is 29/630, or 0.04603. The two selectivities are then multiplied together to calculate the selectivity for the conjunctive predicate “WHERE (country_id=‘US’) AND (cust_state_province=‘CA’)”, which is (0.26190)*(0.04603), or 0.01205.

However, using the multiplicative product of the selectivities of individual predicates as an estimate of the selectivity of the conjunctive predicate yields an accurate estimate only if the selectivities of the individual predicates are uncorrelated. In the example above, the individual predicates are actually very correlated because rows that contain the value ‘CA’ in the cust_state_province column necessarily contain the value ‘US’ in the country_id column. As a result, query Q2 actually returns 29 rows. Therefore, the actual selectivity for the conjunctive predicate is 29/630, or 0.04603. The estimated selectivity, 0.01205, thus introduces an error of 73%.

Thus, a better method for estimating the selectivity of a conjunctive predicate that references a group of columns is needed.

Predicates in queries can also contain expressions of columns, such as built-in SQL functions or arithmetic expressions. Query Q3 illustrates a query that contains a predicate that includes an expression of a column, or column expression.

```
Q3 = SELECT *
      FROM customers
      WHERE lower(country_id) = ‘us’
```

Query Q3 queries for rows in the table customers that contain values in the “country_id” column whose lower case is equal to ‘us’. For this type of query, column statistics on the “country_id” column are not helpful in predicting the selectivity of the predicate because the column is wrapped in an expression. In this case, the column “country_id” is wrapped in the SQL function lower, which returns the lower case of the column value. To calculate the selectivity of predicates that contain expressions of columns, one method uses a default selectivity value, such as a constant value of 5%. In many cases, the default selectivity value introduces large estimation errors.

Thus, a better method for estimating the selectivity of a predicate that includes column expressions is needed.

Note that the word “expression” includes simple expressions that only refers to a single column. For example, “c1” is an expression. As discussed above, gathering statistics for single columns and using these statistics to estimate selectivities is straightforward. As used herein, however, “column expressions” and “expressions of column” refer to non-simple expressions, which include any expression that is more complex than a single column. For example, “lower(c1)” and “c1+c2” are both non-simple expressions.

### Gathering and using Statistics for Column Groups and Column Expressions

Accordingly, to facilitate more accurate estimation of the selectivity of column groups and column expressions in query predicates, statistics for column groups and column expressions are gathered.

According to one embodiment, statistics for column expressions are gathered by defining virtual columns based on the column expressions. Virtual columns are described in U.S. patent application Ser. No. 11/951,890, Attorney Docket No. 50277-3344, titled Virtual Columns, filed by Subhransu Basu and Harmeek Singh Bedi on Dec. 6, 2007. As described in U.S. patent application Ser. No. 11/951,890, statistics may be gathered for a virtual column like for a regular column. Thus, once a virtual column has been defined to be based on a particular column expression, statistics on the particular column expression may be gathered for the particular column expression by gathering statistics on the virtual column.

For example, for query Q3 above, a virtual column can be defined to be “lower (country_id)” and statistics may be gathered for the virtual column so defined. These statistics may then be used to estimate the selectivity of the join predicate in query Q3 (i.e. “WHERE lower (country_id)=‘US’”). Statistics may be gathered for a virtual column in the same fashion as statistics are gathered for regular columns. Both NDV values and histograms (e.g., frequency histograms, height balanced histograms, etc.) may be gathered for virtual columns, and both NDV values and histograms gathered for a virtual column may be used to estimate the selectivity of a predicate, as already discussed above with respect to regular columns.

According to one embodiment, statistics for column groups are gathered by defining virtual columns based on expressions that uniquely identify the column groups. Virtual columns, as discussed in U.S. patent application Ser. No. 11/951,890, are derived by computation of an expression, which in turn can reference regular columns. For example, if columns A and B are two regular columns, then a virtual column C can be defined to be the sum of A and B. Also, as just discussed, statistics may be gathered for virtual columns in the same fashion as statistics for regular columns. Thus, one method of gathering statistics for a group of columns is to define a virtual column based on an expression that includes all of the columns in the group of columns, and to gather statistics for the virtual column so defined.

In defining a virtual column based on an expression that includes the columns of a column group, it is important to use an expression that uniquely maps to the combination of values in the columns of the column group. In other words, the expression used should retain, as much as possible, the uniqueness of the column combinations in the column group. For example, consider columns c1 and c3 in table 100 in FIG. 1. Suppose that the query optimizer is analyzing a query that contains a conjunctive predicate that references the column group of c1 and c3, and that statistics for the column group of c1 and c3 would be helpful in determining the selectivity of the conjunctive predicate. Suppose that a virtual column c4 is defined to be the sum of c1 and c3, and that statistics are gathered for virtual column c4. The values of virtual column c4 are included in table 100, and illustrate that for every row, the value in column c4 is 7. The values in column c4 are not unique for each combination of the values in columns c1 and c3. A combination of 4 in c1 and 3 in c3 results in a value of 7 in column c4, as does the combination of 3 in c1 and 4 in c3. Therefore, the statistics in column c4 are not useful in conveying information about the values in the column group of c1 and c3.

Consider another virtual column, c5, defined to be the concatenation of c1 and c3. The values of virtual column c5 are also included in table 100. The values in every row of virtual column c5 are unique. This uniqueness means that statistics gathered for column c5 can be relied on to represent the statistics of the column group of c1 and c3. In an example, a conjunctive predicate is “WHERE (c1=2) AND (c3=5)”. To estimate the selectivity of this conjunctive predicate, the values ‘2’ and ‘5’ are concatenated together for a result of ‘25’. Next, the statistics for virtual column c5 are examined for statistics on the value of ‘25’. Then, the statistics for the value of ‘25’ is used to estimate the selectivity. For example, if the statistics for virtual column c5 indicates that one-sixth of the values of c5 are ‘25’, then the selectivity for “WHERE (c1=2) AND (c3=5)” may be estimated to be one-sixth. If only the NDV for c5 is gathered, then the inverse of the NDV may be used as an estimate of the selectivity. In contrast, the statistics gathered for virtual column c4 merely indicate that all values in virtual column c4 are 7. As a result, the selectivity for “WHERE (c1=2) AND (c3=5)” would be erroneously estimated as 100%. These examples illustrate the importance of defining a virtual column using an expression that combines multiple columns that preserves the uniqueness of the column combinations.

The concatenation function, however, may not always preserve the uniqueness of column combinations. Therefore, according to one embodiment, virtual columns are defined for multiple columns using an expression that is based on the hash values of the multiple columns. Hash functions perform better than concatenation functions in the preservation of the uniqueness of column combinations. In the example above, a virtual column c6 (not illustrated in table 100) may be defined to be “hash(c1, hash(c3, 0))”, where the first argument is the individual columns of the column group and second argument of the hash function is the seed. Although this example only involves two columns, this expression may be extended to include any number of columns that correspond to any number of ANDed predicates. Using the hash expression just illustrated preserves the uniqueness of column combinations with a small percentage of column collisions, or errors. This small error rate is acceptable because the statistics are only used to estimate the selectivity of a predicate. According to another embodiment, sanity checks may be performed to detect collisions by checking that the selectivity of a column group is not more than any of the selectivities of the individual columns.

### Estimating Selectivities from Statistics of Non-Matching Column Grous

Statistics for a particular column group may not always be available because the gathering and storing of statistics on columns, including virtual columns, requires the usage of limited system resources such as computing power and storage space. However, the selectivity of a particular column group may be estimated from statistics of another column group whose columns do not completely match the columns in the particular column group.

According to one embodiment, the selectivity of a group of two columns is estimated based on the statistics for a group of three columns, if the group of three columns includes the two columns in the group of two columns. First, the selectivity for the group of three columns is estimated based on the statistics for the group of three columns. The selectivity of three columns is always less than the selectivity of two columns, if the two columns are included in the three columns. Therefore, the selectivity of the group of two columns may be estimated to be at least the selectivity of the group of three columns.

For example, the selectivity of a group of two columns, “country” and “state”, may be estimated based on statistics gathered for the group of three columns that contains the columns “country”, “state”, and “city”. The selectivity of the column group of “country”, “state”, and “city” is estimated based on the statistics for that column group. More specifically, statistics in the form of NDV values may be used. Because the selectivity of the column group of “country” and “state” is always greater than or equal to the selectivity of the column group of “country”, “state”, and “city”, the selectivity of the column group of “country”, “state”, and “city” may be used as the lower-bound estimate of the selectivity of the column group of “country” and “state”. Although this example only discusses column groups of two and three columns, this estimation technique can be applied to any two column groups where statistics are available for a column group that includes all the columns in the other column group. For example, the selectivity of a three-column column group can be estimated based on the selectivity of a four-column column group, the selectivity of a four-column column group can be estimated based on the selectivity of a six-column column group, and so on.

According to another embodiment, the selectivity for a first column group are estimated based on the statistics for a second column group that contains some columns in common with the columns in the particular column group, where the second column group is the column group among all column groups for which statistics are collected that contains the most number of common columns with the particular column group. In an example, the selectivity of a column group consisting of the columns c1, c2, c3, and c4 is to be estimated. No statistics have been gathered for the column group of c1, c2, c3, and c4. However, statistics have been gathered for the column group of c1 and c2, for the column group of c3, and c4, and for the column group of c1, c2, and c3. Based on these available statistics, two estimations can be made for the selectivity of the column group of c1, c2, c3, and c4:

E1=selectivity of (c1, c2)*selectivity of (c3, c4)

E2=selectivity of (c1, c2, c3)*1/(NDV(c4))

The column group of c1, c2, c3, which contains three columns in common with the column group of c1, c2, c3, and c4, contains more columns in common with the column group of c1, c2, c3, and c4 than the column group of c1 and c2 and the column group of c3 and c4. Accordingly, in this example, E2 is selected as the estimate of the selectivity for the column group of c1, c2, c3, and c4.

According to another embodiment, when either the statistics of a first column group or the statistics of a second column group can be used to calculate the selectivity of a third column group, the selectivity of the third column group is calculated based on the statistics of whichever one of the first column group or the second column group that has the higher correlation strength. This technique can also be extended to apply to cases where the statistics of more than two column groups are available.

The correlation strength of a column group is the NDV of the column group divided by the product of the NDVs of the individual columns in the column group. For example, if a column group consists of two columns c1 and c2, then the column group's correlation strength is:

C(c1, c2)=(NDV(c1)*NDV(c2))/NDV of (c1, c2)

Continuing with this example, suppose that the selectivity of the column group of columns c1, c2, and c3 is to be estimated, and that statistics for the column group of c1 and c2 and the column group of c2 and c3 are available. Based on these available statistics, two estimations can be made for the selectivity of the column group of c1, c2, and c3:

E1=selectivity of (c1, c2)*1/(NDV(c3))

E2=selectivity of (c2, c3)*1/(NDV(c3))

If the correlation strength of the column group of c1 and c2 is greater than the correlation strength of the column group of c2 and c3, then in this example, E1 would be selected as the selectivity estimated for the column group of c1, c2, and c3.

According to another embodiment, the selectivity for a column group may be estimated based on statistics that are derived from indexes of column groups. For an index that indexes a group of columns, the number of index keys is stored as a statistic. This number of index keys statistic can be used as an estimate of the NDV of the group of columns that has been indexed, and can then be used to derive selectivity estimates as discussed above.

### Estimating Selectivities for Join Predicates Involving Multiple Tables

The predicates discussed so far are of the form “column=constant”. However, many predicates in queries contain joins between multiple tables.

According to one embodiment, the selectivity of two join predicates that joins two tables on two common columns may be estimated as the product of the number of rows in the first table and the number of rows in the second table, divided by the NDV of the first common column or the NDV of the second common column, whichever one is greater. Consider the following query Q4.

```
Q4 = SELECT *
      FROM t2, t3
      WHERE (t2.c1 = t3.c1) AND (t2.c2 = t3.c2)
```

Accordingly, the selectivity for the conjunctive predicate of “WHERE (t2.c1=t3.c1) AND (t2.c2=t3.c2)” can be estimated as

E=n1*n2/MAX(NDV(t2.c1, t2.c2), NDV(t3.c1, t3.c2))

where n1 and n2 are the number of rows in tables t1 and t2, respectively.

### System Overview and Determination of Column Groups and Expressions for Statistics-Gathering

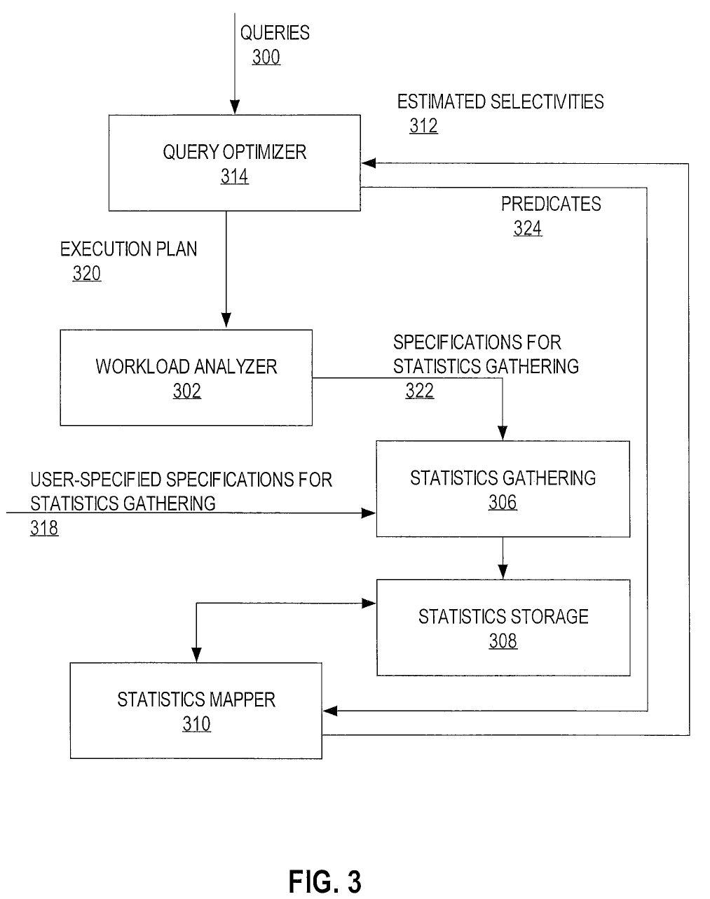

FIG. 3 is a diagram that illustrates an overview of a system for gathering statistics for column groups and expressions and for utilizing the gathered statistics. The modules in FIG. 3 are for illustrative purposes. The methods described herein may be implemented in a variety of configurations that may not contain the same modules as those depicted in FIG. 3.

In FIG. 3, queries 300 are submitted to a DBMS 316. Within the DBMS 316, the queries 300 are analyzed by query optimizer 314, which generates several candidate execution plans and selects one execution plan for the query. The execution plan 320, which includes predicates, is then analyzed by workload analyzer 302 and statistics mapper 310.

As discussed above, statistics are gathered for column groups and expressions of columns to facilitate the estimation of selectivities for predicates that reference multiple columns or expressions of columns. However, it may be impractical to gather statistics for every possible column group and expression of columns, as the gathering and storing of statistics utilizes computing and storage resources. Therefore, according to one embodiment, a workload analyzer, such as workload analyzer 302 in FIG. 3, analyzes the predicates in execution plan 320 and determines which column groups and expressions of columns would be most useful to gather statistics on. Workload analyzer further determines what type of statistics (e.g., NDV, histogram etc.) should be gathered for specific column groups and expressions of columns.

In FIG. 3, workload analyzer 302 outputs specifications 322 to statistics gathering module 306. The specifications specify the column groups and expressions of columns for statistics gathering, as well as the type of statistics (e.g., NDV, histogram, etc.) that should be gathered. Statistics gathering module 306 gathers the statistics for the column groups and expressions 304 specified by workload analyzer 302. According to another embodiment, users of the DBMS may also specify to the statistics gathering module 306 the kind of statistics that the user desire gathered. Thus, statistics gathering module 306 also gathers statistics for the specifications 318 specified by users. The statistics gathered by the statistics gathering module 306 is stored in statistics storage module 308.

Because statistics are not gathered for every possible combination of columns and every possible expression of columns, estimation of the selectivity for a predicate may be based on statistics of column groups and expressions of columns that do not perfectly match the column groups and expressions of columns specified in the predicate. Statistics mapper 310 maps query predicates 324 to the most appropriate statistics from statistics storage 308 for the query predicates. Techniques for performing this mapping are discussed above.

Once the most appropriate statistics are mapped to a query predicate, an estimate of the selectivity of the query predicate may be performed. Techniques for estimating selectivities are discussed above. The step of estimating selectivity may be performed in another module or within the statistics mapper module 310. The resulting estimated selectivity 312 is output to the query optimizer 314.

Finally, query optimizer 314 utilizes the selectivities 312 in estimating the query cost for different candidate execution plans.

### Hardware Overview

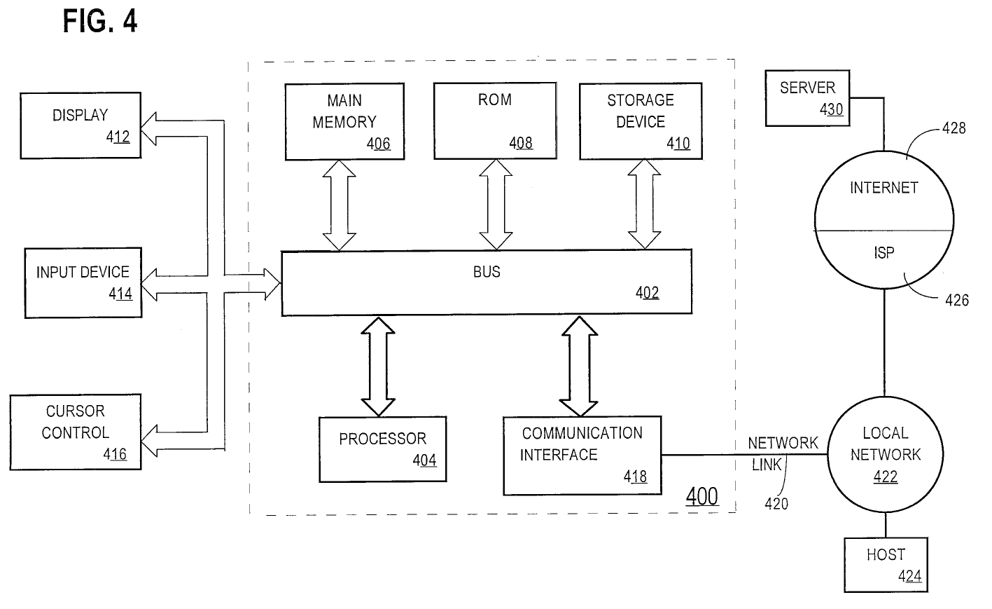

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for estimating a selectivity of a predicate in a query, comprising:
generating statistics of values that are computed based on a non-simple expression that is based on at least one column of a table;
receiving the query that includes the predicate;
mapping the predicate to the non-simple expression; and
estimating, based on the statistics, the selectivity of the predicate.

2. The method of claim 1, wherein mapping the predicate to the non-simple expression comprises determining that the predicate contains the non-simple expression.

3. The method of claim 1, wherein mapping the predicate to the non-simple expression comprises:
determining which columns are referred to in the predicate; and
determining that the non-simple expression is
(1) based on the columns that are referred to in the predicate; and
(2) not based on any column which is not referred to in the predicate.

4. The method of claim 3, wherein the non-simple expression includes a hash function.

5. The method of claim 1, wherein mapping the predicate to the non-simple expression comprises:
determining which columns are referred to in the predicate;
determining that the non-simple expression is
(1) based on the columns that are referred to in the predicate; and
(2) based on at least one column which is not referred to in the predicate.

6. The method of claim 1, wherein estimating comprises:
estimating, based on the statistics, a selectivity of the non-simple expression; and
estimating the selectivity of the predicate to be at least the selectivity of the non-simple expression.

7. The method of claim 1,
wherein the non-simple expression is one non-simple expression in a plurality of non-simple expressions for which statistics are generated; and
wherein mapping the predicate to the non-simple expression comprises:
determining that the non-simple expression includes a highest number of columns in common with the predicate among all non-simple expressions in the plurality of non-simple expressions.

8. The method of claim 1,
wherein the non-simple expression is one non-simple expression in a plurality of non-simple expressions for which statistics are generated; and
wherein mapping the predicate to the non-simple expression comprises:
determining that the non-simple expression has a highest correlation strength value among all non-simple expressions in the plurality of non-simple expressions.

9. The method of claim 1, wherein generating statistics comprises generating statistics based on statistics of an index for the non-simple expression.

10. The method of claim 1, wherein the statistics comprise a histogram.

11. The method of claim 1, wherein the statistics comprise a number of distinct values.

12. A computer-readable storage medium storing instructions, the instructions including instructions which, when executed by one or more processors, cause the one or more processors to perform the steps of:
generating statistics of values that are computed based on a non-simple expression that is based on at least one column of a table;
receiving the query that includes the predicate;
mapping the predicate to the non-simple expression; and
estimating, based on the statistics, the selectivity of the predicate.

13. The computer-readable storage medium of claim 11, wherein instructions for mapping the predicate to the non-simple expression comprises instructions for determining that the predicate contains the non-simple expression.

14. The computer-readable storage medium of claim 11, wherein instructions for mapping the predicate to the non-simple expression comprises instructions for:
determining which columns are referred to in the predicate; and
determining that the non-simple expression is
(1) based on the columns that are referred to in the predicate; and
(2) not based on any column which is not referred to in the predicate.

15. The computer-readable storage medium of claim 13, wherein the non-simple expression includes a hash function.

16. The computer-readable storage medium of claim 11, wherein instructions for mapping the predicate to the non-simple expression comprises instructions for:
determining which columns are referred to in the predicate;
determining that the non-simple expression is
(1) based on the columns that are referred to in the predicate; and
(2) based on at least one column which is not referred to in the predicate.

17. The computer-readable storage medium of claim 11, wherein instructions for estimating comprises instructions for:
estimating, based on the statistics, a selectivity of the non-simple expression; and
estimating the selectivity of the predicate to be at least the selectivity of the non-simple expression.

18. The computer-readable storage medium of claim 11,
wherein the non-simple expression is one non-simple expression in a plurality of non-simple expressions for which statistics are generated; and
wherein instructions for mapping the predicate to the non-simple expression comprises:
instructions for determining that the non-simple expression includes a highest number of columns in common with the predicate among all non-simple expressions in the plurality of non-simple expressions.

19. The computer-readable storage medium of claim 11,
wherein the non-simple expression is one non-simple expression in a plurality of non-simple expressions for which statistics are generated; and
wherein instructions for mapping the predicate to the non-simple expression comprises:
instructions for determining that the non-simple expression has a highest correlation strength value among all non-simple expressions in the plurality of non-simple expressions.

20. The computer-readable storage medium of claim 11, wherein the instructions for generating statistics comprises instructions for generating statistics based on statistics of an index for the non-simple expression.

21. The computer-readable storage medium of claim 11, wherein the statistics comprise a histogram.

22. The computer-readable storage medium of claim 11, wherein the statistics comprise a number of distinct values.
